(19) United States
(12) Patent Application Publication
(10) Pub. No.: US 2019/0334980 A1
(43) Pub. Date: Oct. 31, 2019

(54) NETWORK DEVICE SUPPORT MECHANISM

(71) Applicant: Hewlett Packard Enterprise Development LP, Houston, TX (US)

(72) Inventors: Yashavantha NAGARAJU, Bangalore Karnataka (IN); Nitin SINGLA, Bangalore Karnataka (IN); Tathagata NANDY, Bangalore Karnataka (IN)

(21) Appl. No.: 16/360,315

(22) Filed: Mar. 21, 2019

(30) Foreign Application Priority Data
Apr. 26, 2018 (IN) IN 201841015875

(51) Int. Cl. H04L 29/08; G06F 9/50

(52) U.S. Cl. CPC H04L 67/1008; H04L 67/1014; H04L 67/1034; G06F 9/5055; H04L 67/322; H04L 67/327; H04L 67/36

(57) ABSTRACT

Examples disclosed herein relate to a method comprising receiving, at a server mechanism of a first network device, a request to perform an operation, determining, by the server mechanism, that the request is for a second network device belonging to a network, wherein the first and second network devices belong to the network. The method may also include determining, by the server mechanism, that the second network device cannot perform the requested operation, performing, by the server mechanism, the operation and responding, by the server mechanism, to the request.

### BACKGROUND

A network device, such as a switch, may run an operating system and may have certain integrated features of the device and/or operating system. Accordingly, different devices on a network may have difference feature sets.

### BRIEF DESCRIPTION OF THE DRAWINGS

The following detailed description references the drawings, wherein:

FIG. 1 is a block diagram of an example system where a network device support mechanism may be useful;

FIG. 2 is a flowchart of an example method for using a network device support mechanism;

FIG. 3 is a flowchart of for accessing data using a network device support mechanism;

FIG. 4 is a flowchart of an example method for translating requests using a network device support mechanism;

FIG. 5 is a flowchart of another example Method for using a network device support mechanism; and

FIG. 6 is a block diagram of another example system for a network device support mechanism.

### DETAILED DESCRIPTION

A network may be made up a variety of different network devices. These devices are typically obtained and/or replaced over a long period of time, so different devices on the network may have different capabilities. Newer devices, for example, may have more powerful hardware, such as a more capable processor, more memory etc., certain devices may have different operating systems with different features. Moreover, different devices may have dedicated hardware to more effectively handle certain types of requests, different sensors and/or other equipment for obtaining data, different access to obtain data from the network, etc.

Because of this, certain devices on a network may have the capability to perform certain operations, while other devices on the network may not have the capability to perform certain operations. Accordingly, a user request to perform an operation may be easily handled by certain devices but may be unable to complete by other devices. This may create a problem for the user, who would like an operation to be performed on less capable device, or on data associated with that less capable device. Moreover, a user may have to manually keep track of which devices on the network have which capabilities. This problem may be exacerbated as the number of devices and data on a network grows.

Aspects of the system and method for network support device network described herein, provide a mechanism of a first, typically more capable device, to act as a stand in for requests of another, typically less capable device. In this manner, an older device can make use of features and hardware of a newer device.

The support mechanism may be a dedicated feature, hardware feature and/or software device running on a first device, typically a newer and/or higher end device which may act as an intermediary between the first device and a second device typically having less features than the first device. In some aspects, the request may be received from a higher end device and a response is generated from the lower end side.

Whenever a user request or traffic comes for the second device, the request may be received by the mechanism (operating on the first device). In this manner, the requests coming in for the second device may be handled by the server mechanism. The mechanism may determine whether the second device is capable of fully handling the request. If the second device is capable of handling the request, the request may be forwarded to the second device for processing. If the second device is not capable of fully handling the request, the mechanism may handle the request. After completing the request, the mechanism may relate it with the original request and then respond to the request.

A method for switch configuration troubleshooting may include receiving, at a server mechanism of a first network device, a request to perform an operation and determining, by the server mechanism, that the request is for a second network device belonging to a network, wherein the first and second network devices belong to the network. The method may also include determining, by the server mechanism, that the second network device cannot perform the requested operation, performing, by the server mechanism, the operation and responding, by the server mechanism, to the request.

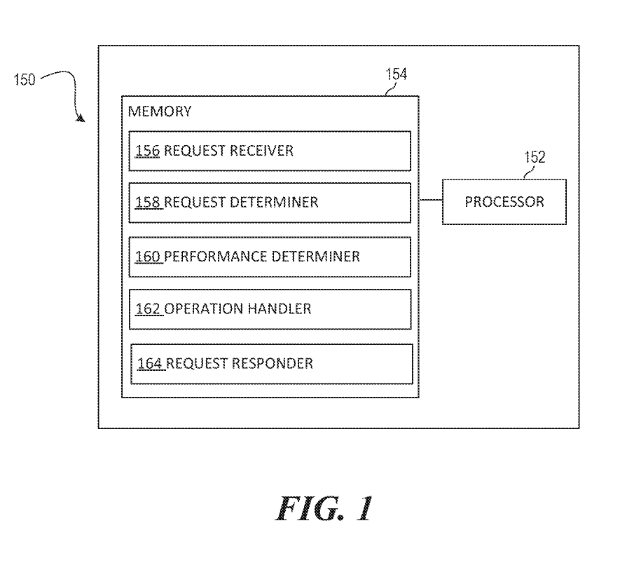

FIG. 1 is a block diagram of example system 150 where a network device support mechanism may be useful. System 150 may include a processor 152 and a memory 154 that may be coupled to each other through a communication link (e.g., a bus). Processor 152 may include a single or multiple Central Processing Units (CPU) or another suitable hardware processor(s). In some examples, memory 154 stores machine readable instructions executed by processor 152 for system 150. Memory 154 may include any suitable combination of volatile and/or non-volatile memory, such as combinations of Random Access Memory (RAM), Read-Only Memory (ROM), flash memory, and/or other suitable memory.

Memory 154 stores instructions to be executed by processor 152 including instructions for request receiver 156, request determiner 158, performance determiner 160, operation handler 162, request responder 164, and/or other components. According to various implementations, system 150 may be implemented in hardware and/or a combination of hardware and programming that configures hardware. Furthermore, in FIG. 1 and other Figures described herein, different numbers of components or entities than depicted may be used.

Processor 152 may execute request receiver 156 to receive, at a server mechanism of a first network device, a request to perform an operation. Processor 152 may execute request determiner 158 to determine, by the server mechanism, that the request is for a second network device belonging to a network, wherein the first and second network devices belong to the network. The second network device may not have the capability to perform the operation and the first network device may have the capability to perform the operation. For example, the second network device may run an operating system that does not have the functionality to perform the operation. The request may correspond to data associated with the second network device.

Processor 152 may execute performance determiner 160 to determine, by the server mechanism, that the second network device cannot perform the requested operation. Processor 152 may execute operation handler 162 to perform, by the server mechanism, the operation. Processor 152 may execute request responder 164 to respond, by the server mechanism, to the request.

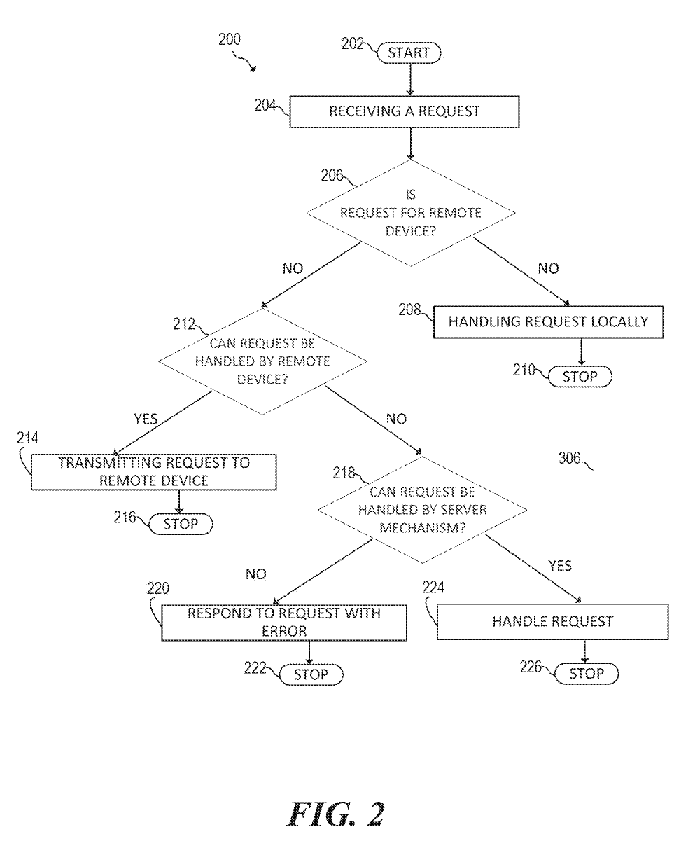

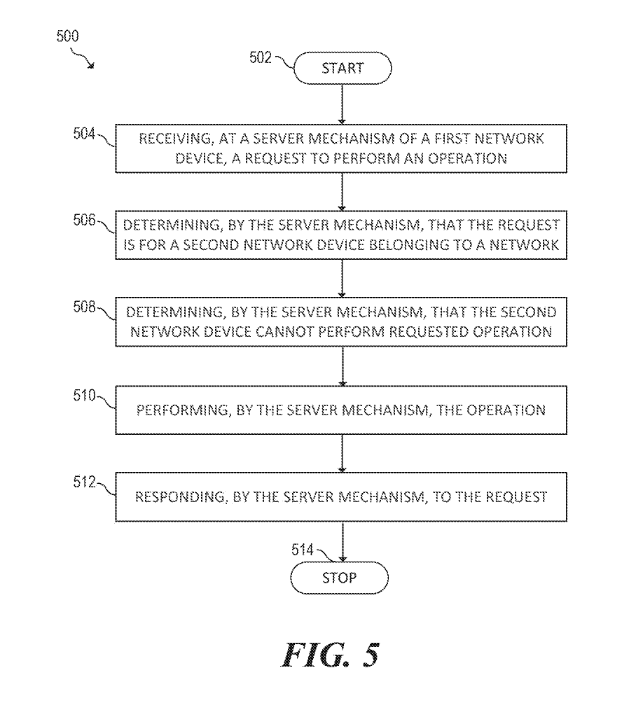

Referring now to FIGS. 2-4, flow diagrams are illustrated in accordance with various examples of the present disclosure. The flow diagrams represent processes that may be utilized in conjunction with various systems and devices as discussed with reference to the preceding figures, such as, for example, system 150 described in reference to FIG. 1 and/or system 500 described in reference to FIG. 5. While illustrated in a particular order, the flow diagrams are not intended to be so limited. Rather, it is expressly contemplated that various processes may occur in different orders and/or simultaneously with other processes than those illustrated. As such, the sequence of operations described in connection with FIGS. 2-4 are examples and are not intended to be limiting. Additional or fewer operations or combinations of operations may be used or may vary without departing from the scope of the disclosed examples. Thus, the present disclosure merely sets forth possible examples of implementations, and many variations is and modifications may be made to the described examples.

FIG. 2 is a flowchart of an example method 200 for using a network device support mechanism. Method 200 may start at block 202 and continue to block 204, where the method 200 may include receiving a request. At block 206, the method may include determining that the request is for a remote device. If it is determined that the request is not for a remote device (No branch of block 206), at block 208 the method may determine that the request is for the device itself and/or handling the request locally. The method may then proceed to block 210, where the method may end.

If it is determined that the request is for a remote device (Yes branch of block 206), at block 212, the method may include deterring if the request can be handled by the remote device. If it is determined that the request can be handled by the remote device (Yes branch of block 212), at block 214, the method may include transmitting the request to the remote device. The method may then proceed to block 216, where the method may end.

If it is determined that the request cannot be handled by the remote device (No branch of block 212), at block 218, the method may include determining whether the request can be handled by the server mechanism. If it is determined that the request cannot be handled by the server mechanism (No branch of block 218), at block 220, the method may include responding to the request with an error. The method may then proceed to block 222, where the method may end.

If it is determined that the request can be handled by the server mechanism (Yes branch of block 218), at block 224, the method may include handling the request.

For example, a version of an operating system (OS) running on a device (i.e. high end device) may support an analytics feature that is not supported on a low end device. Accordingly, each request on the network for using that feature may be routed to the stand in mechanism. If the request is for the high end device, the stand in mechanism may forward the request to a monitor of the high end system to perform the analytics request. If the request is for analytics to be performed on the low end device, the stand in mechanism may forward the request to the analytics monitor of the high end device. One or both of the stand in mechanism and/or high end device may transmit a separate request to the low end device for additional data related to the low end device. In this way, the low end device can also make the use of high end features and capabilities. Of course this is an example for exemplary purposes and other features and numbers of devices may be used with the techniques described herein. The method may then proceed to block 226, where the method may end.

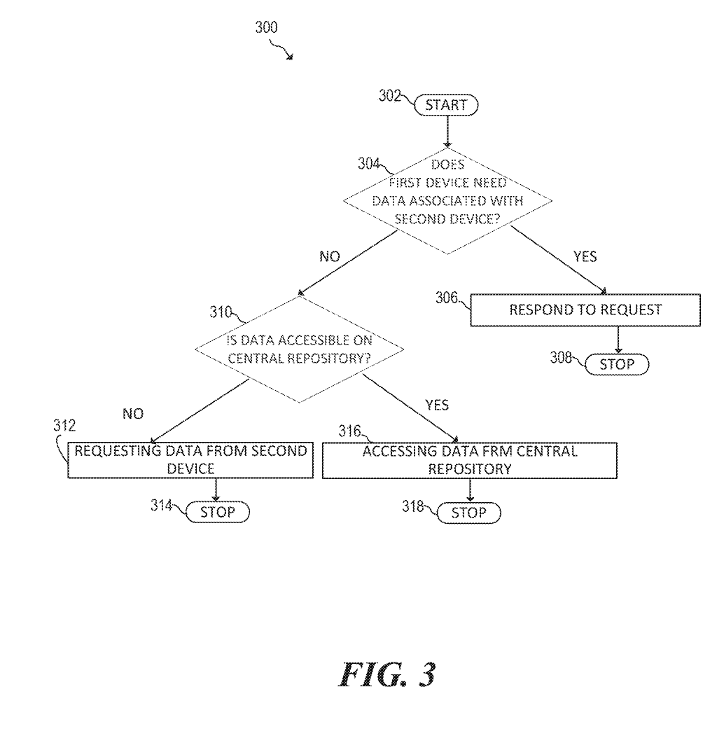

FIG. 3 is a flowchart of an example method 300 for accessing data using a network device support mechanism. Method 300 may start at block 302 and continue to block 304, where the method may include determining that the first device needs data associated with the second device. If it is determined that the first device does not need data associated with the second device (No branch of block 304), at block 306 the method may include responding to the request. The method may then proceed to block 308, where the method may end.

If it is determined that the first device does need data associated with the second device (Yes branch of block 304), at block 310 the method may determining whether the data associated with the second device is accessible on a central repository. If it is determined that the data associated with the second device is not accessible on a central repository (No branch of block 310), at block 312 the method may include requesting the data from the second device. The method may then proceed to block 314, where the method may end.

If it is determined that the data associated with the second device is accessible on a central repository (Yes branch of block 310), at block 316 the method may include accessing the data from the central repository. The method may then proceed to block 318, where the method may end.

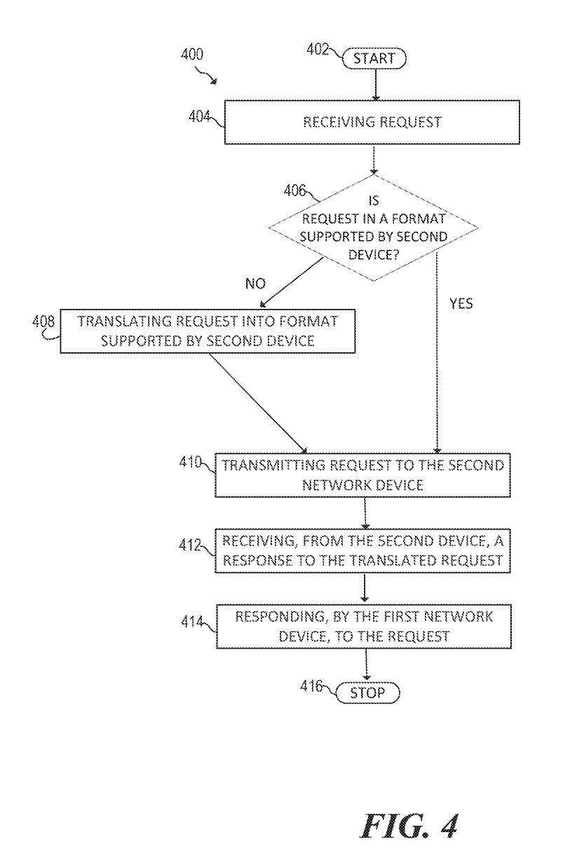

FIG. 4 is a flowchart of an example method 400 for translating requests using a network device support mechanism. Method 400 may start at block 402 and continue to block 404, where the method 400 may include receiving a request. At block 406, the method may include determining whether the request is in a format supported by the second device. If it is determined that the request is not in a format supported by the second device (No branch of block 406), at block 408 the method may include translating the request into a format supported by the second device. After the request has been translated into a format supported by the second device or if it is determined that the request is in a format supported by the second device (Yes branch of block 406), at block 410 the method may include transmitting the request to the second device. At block 412, the method may include receiving from the second device a response to the translated request. At block 414, the method may include responding, by the first network device, to the request. The method may proceed to block 416, where the method may end.

For example, in some aspects a similar feature may be supported by numerous devices in the network, but the feature may different names for different devices and/or different OS versions. In these aspects, the stand-in mechanism and/or method 400 may be used to translate a first request for a first device, the request having a first name supported by the first device, into a second request for the second device, the second request being supported by the second device. In this case, the first and second request may be for a similar functionality having a first name and/or format on the first device and a second name and/or format on the second device.

FIG. 5 is a flowchart of an example method 500 for using a network device support mechanism. Method 500 may start at block 502 and continue to block 504, where the method 500 may include receiving, at a server mechanism of a first network device, a request to perform an operation. At block 506, the method may include determining, by the server mechanism, that the request is for a second network device belonging to a network, wherein the first and second network devices belong to the network. At block 508, the method may include determining, by the server mechanism, that the second network device cannot perform the requested operation. The second network device may not have the capability to perform the operation and the first network device may have the capability to perform the operation. For example, the second network device may run an operating system that does not have the functionality to perform the operation. The request may correspond to data associated with the second network device.

At block 510, the method may include performing, by the server mechanism, the operation. At block 512, the method may include responding, by the server mechanism, to the request. The method may proceed to block 514, where the method may end.

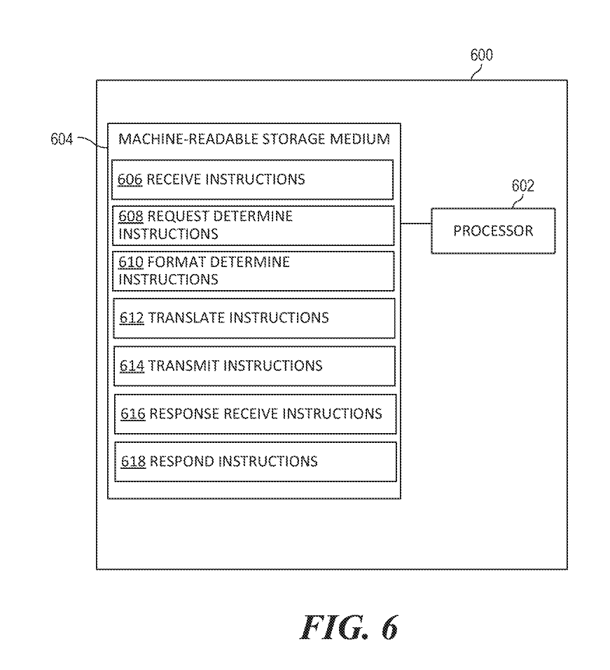

FIG. 6 is a block diagram of an example system 600 for using a network device support mechanism. In the example illustrated in FIG. 6, system 600 includes a processor 602 and a machine-readable storage medium 604. In some aspects, processor 602 and machine-readable storage medium 604 may be part of an Application-specific integrated circuit (ASIC). Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 602 may be at least one central processing unit (CPU), microprocessor, and/or other hardware devices suitable for retrieval and execution of instructions stored in machine-readable storage medium 604. In the example illustrated in FIG. 6, processor 602 may fetch, decode, and execute instructions 606, 608, 610, 612, 614, 616 and 618 for using a network device support mechanism. Processor 602 may include at least one electronic circuit comprising a number of electronic components for performing the functionality of at least one of the instructions in machine-readable storage medium 604. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 604 may be any electronic, magnetic, optical, or other physical storage device that stores executable instructions. Thus, machine-readable storage medium 604 may be, for example, Random Access Memory (RAM), an Electrically-Erasable Programmable Read-Only Memory (EEPROM), a storage drive, an optical disc, and the like. Machine-readable storage medium 604 may be disposed within system 600, as shown in FIG. 6. In this situation, the executable instructions may be “installed” on the system 600. Machine-readable storage medium 604 may be a portable, external or remote storage medium, for example, that allows system 600 to download the instructions from the portable/external/remote storage medium. In this situation, the executable instructions may be part of an “installation package”. As described herein, machine-readable storage medium 604 may be encoded with executable instructions for context aware data backup. The machine-readable storage medium may be non-transitory.

Referring to FIG. 6, receive instructions 606, when executed by a processor (e.g., 602), may cause system 600 to receive, at a server mechanism of a first network device, a request to perform an operation. Request determine instructions 608, when executed by a processor (e.g., 602), may cause system 600 to determine, by the server mechanism, that the request is for a second network device belonging to a network, wherein the first and second network devices belong to the network. The request may correspond to data associated with the second network device.

In some aspects, the system 600 may also include instructions that when executed by a processor (e.g. 602), may cause system 600 to determine that the request can be performed by the second device. The second network device may runs an operating system that has the functionality to perform the operation.

Format determine instructions 610, when executed by a processor (e.g., 602), may cause system 600 to determine that the request is not in a format supported by the second device. Translate instructions 612, when executed by a processor (e.g., 602), may cause system 600 to translate the request from a first format supported by the first device to a second format supported by the second network device. Transmit instructions 614, when executed by a processor (e.g., 602), may cause system 600 to transmit the translated request to the second network device.

Response receive instructions 616, when executed by a processor (e.g., 602), may cause system 600 to receive, from the second device, a response to the translated request. Respond instructions 618, when executed by a processor (e.g., 602), may cause system 600 to respond, by the first network device, to the request.

The foregoing disclosure describes a number of examples for using a network device support mechanism. The disclosed examples may include systems, devices, computer-readable storage media, and methods for using a network device support mechanism. For purposes of explanation, certain examples are described with reference to the components illustrated in FIGS. 1-5. The content type of the illustrated components may overlap, however, and may be present in a fewer or greater number of elements and components. Further, all or part of the content type of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

I/We claim:

1. A method comprising:
receiving, at a server mechanism of a first network device, a request to perform an operation;
determining, by the server mechanism, that the request is for a second network device belonging to a network, wherein the first and second network devices belong to the network;
determining, by the server mechanism, that the second network device cannot perform the requested operation;
performing, by the server mechanism, the operation; and
responding, by the server mechanism, to the request.

2. The method of claim 1, wherein the request corresponds to data associated with the second network device

3. The method of claim 1, comprising:
determining, by the server mechanism, that first network device does not have data associated with the second network device.

4. The method of claim 3, comprising:
transmitting, to the second network device, a second request for the data associated with the second network device.

5. The method of claim 3, comprising:
accessing, from a central repository accessible by the first and second network devices, the data associated with the second network device.

6. The method of claim 1, wherein the second network device does not have the capability to perform the operation and the first network device has the capability to perform the operation.

7. The method of claim 1, wherein the second network device runs an operating system that does not have the functionality to perform the operation.

8. The method of claim 1, comprising:
determining that the first network device is capable of performing the request.

9. A system comprising:
a request receiver to receive, at a server mechanism of a first network device, a request to perform an operation;
a request determines to determine, by the server mechanism, that the request is for a second network device belonging to a network, wherein the first and second network devices belong to the network;
a performance determiner to determine, by the server mechanism, that the second network device cannot perform the requested operation;
an operation handier to perform, by the server mechanism, the operation; and
a request responder to respond, by the server mechanism, to the request.

10. The system of claim 9, wherein the request corresponds to data associated with the second network device

11. The system of claim 10, comprising:
a data handier to determine, by the server mechanism, that first network device does not have data associated with the second network device.

12. The system of claim 12, comprising:
the data handler to transmit, to the second network device, a second request for the data associated with the second network device.

13. The system of claim 12, comprising:
the data handler to access, from a central repository accessible by the first and second network devices, the data associated with the second network device.

14. The system of claim 10, wherein the second network device does not have the capability to perform the operation and the first network device has the capability to perform the operation.

15. The system of claim 10, wherein the second network device runs an operating system that does not have the functionality to perform the operation.

16. The system of claim 10, comprising the performance determiner to:
determine that the first network device is capable of performing the request.

17. A non-transitory machine-readable storage medium encoded with instructions, the instructions executable by a processor of a system to cause the system to:
receive, at a server mechanism of a first network device, a request to perform an operation;
determine, by the server mechanism, that the request is for a second network device belonging to a network, wherein the first and second network devices belong to the network;
determine that the request is not in a format supported by the second device
translate the request from a first format supported by the first device to a second format supported by the second network device;
transmit the translated request to the second network device;
receive, from the second device, a response to the translated request; and
respond, by the first network device, to the request.

18. The non-transitory machine-readable storage medium of claim 17, the instructions executable by the processor to cause the system to:
determine that the request can be performed by the second device.

19. The non-transitory machine-readable storage medium of claim 17, wherein the request corresponds to data associated with the second network device.

20. The non-transitory machine-readable storage medium of claim 17, wherein the second network device runs an operating system that has the functionality to perform the operation.
